(19) United States
(12) Patent Application Publication
(10) Pub. No.: US 2026/0269429 A1
(43) Pub. Date: Sep. 10, 2026

(54) BATTERY CELL

(71) Applicant: TOYOTA JIDOSHA KABUSHIKI KAISHA, Toyota-shi (JP)

(72) Inventors: Satoshi NAKASHIMA, Toyota-shi (JP); Atsushi SUGIHARA, Toyota-shi (JP); Masato ONO, Nagoya-shi (JP); Masayoshi HAGA, Nagoya-shi (JP); Jun IZUMI, Toyota-shi (JP); Masahiro ISHIZUKA, Toyota-shi (JP); Kenta MIYAHARA, Toyota-shi (JP)

(73) Assignee: TOYOTA JIDOSHA KABUSHIKI KAISHA, Toyota-shi (JP)

(21) Appl. No.: 19/464,930

(22) Filed: Jan. 30, 2026

(30) Foreign Application Priority Data
Mar. 10, 2025 (JP) 2025-037103

(51) Int. Cl. H01M 50/533; H01M 50/105; H01M 50/54

(52) U.S. Cl. CPC H01M 50/533; H01M 50/105; H01M 50/54

(57) ABSTRACT

A battery cell includes a power storage body, and an electrode plate. The power storage body includes an electrode laminate in which a plurality of positive electrode current collection foils and a plurality of negative electrode current collection foils are laminated, and a foil-collecting portion in which the positive electrode current collection foils or the negative electrode current collection foils are collected, the foil-collecting portion protruding from a side surface of the electrode laminate. The foil-collecting portion includes a first bent portion, and a specific portion connected to the electrode laminate via the first bent portion and extending along a laminating direction of the electrode laminate. The electrode plate includes a first plate portion disposed along the specific portion and joined to the specific portion, a second bent portion, and a second plate portion connected to the first plate portion via the second bent portion.

### CROSS-REFERENCE TO RELATED APPLICATION

This application claims priority to Japanese Patent Application No. 2025-037103 filed on Mar. 10, 2025. The disclosure of the above-identified application, including the specification, drawings, and claims, is incorporated by reference herein in its entirety.

### BACKGROUND

### Technical Field

A technology disclosed in the present specification relates to a battery cell.

### Description of Related Art

A power storage body of a battery cell disclosed in Japanese Unexamined Patent Application Publication No. 2025-18622 (JP 2025-18622 A) includes an electrode laminate and a foil-collecting portion. The electrode laminate has a structure in which a plurality of positive electrode current collection foils and a plurality of negative electrode current collection foils are laminated. The foil-collecting portion is a portion in which the positive electrode current collection foils or the negative electrode current collection foils are collected. The foil-collecting portion protrudes from a side surface of the electrode laminate. An electrode plate is also referred to as a current collection plate and is joined to the foil-collecting portion. The electrode plate is a terminal that outputs a voltage of the battery cell.

### SUMMARY

In JP 2025-18622 A, the foil-collecting portion extends along a direction (hereinafter, referred to as a lateral direction) intersecting a laminating direction of the electrode laminate. The electrode plate extends further in the lateral direction (that is, the direction in which the foil-collecting portion extends) from a joining position with the foil-collecting portion. Therefore, in a structure of the battery cell of JP 2025-18622 A, a distance from the side surface of the electrode laminate to a distal end of the electrode plate becomes longer, thereby increasing a size of the battery cell. The present specification proposes a technology for reducing the size of the battery cell.

A battery cell disclosed in the present specification includes

a power storage body, and

an electrode plate.

The power storage body includes

an electrode laminate in which a plurality of positive electrode current collection foils and a plurality of negative electrode current collection foils are laminated, and

a foil-collecting portion in which the positive electrode current collection foils or the negative electrode current collection foils are collected, the foil-collecting portion protruding from a side surface of the electrode laminate.

The foil-collecting portion includes

a first bent portion, and

a specific portion connected to the electrode laminate via the first bent portion and extending along a laminating direction of the electrode laminate.

The electrode plate includes a first plate portion disposed along the specific portion and joined to the specific portion,

a second bent portion, and

a second plate portion connected to the first plate portion via the second bent portion and extending from the second bent portion in a direction away from the electrode laminate.

In the battery cell, a joining portion between the foil-collecting portion and the electrode plate (that is, the specific portion and the first plate portion) extends along the laminating direction. The electrode plate is bent at the second bent portion, and the second plate portion extending from the second bent portion extends in a lateral direction. In this structure, since the joining portion between the foil-collecting portion and the electrode plate extends along the laminating direction, a distance from the side surface of the electrode laminate to a distal end of the second plate portion (that is, a dimension in the lateral direction) can be reduced compared to that in the related art. Therefore, with the structure of the battery cell, the battery cell can be reduced in size.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery cell 10;

FIG. 2 is a plan view of the battery cell 10 as viewed along a thickness direction;

FIG. 3 is a cross-sectional view of the battery cell of the embodiment taken along line III-III of FIG. 2;

FIG. 4 is a cross-sectional view of the battery cell before sealing of an outer package;

FIG. 5 is a cross-sectional view of a battery cell of a comparative example corresponding to FIG. 3;

FIG. 6 is an explanatory view of a manufacturing method of the battery cell of the embodiment; and

FIG. 7 is a cross-sectional view of a battery cell of Modification corresponding to FIG. 3.

### DETAILED DESCRIPTION OF EMBODIMENTS

In the example of the battery cell disclosed in the present specification, the foil-collecting portion may be connected to the side surface of the electrode laminate at a position shifted from the center of the electrode laminate in the laminating direction. The second plate portion may be disposed at the center of the electrode laminate in the laminating direction.

With this configuration, the second plate portion can be disposed at the center of the electrode laminate in the laminating direction.

In the example of the battery cell disclosed in the present specification, a film material that encloses the power storage body may be further included. The film material may be welded to the second plate portion.

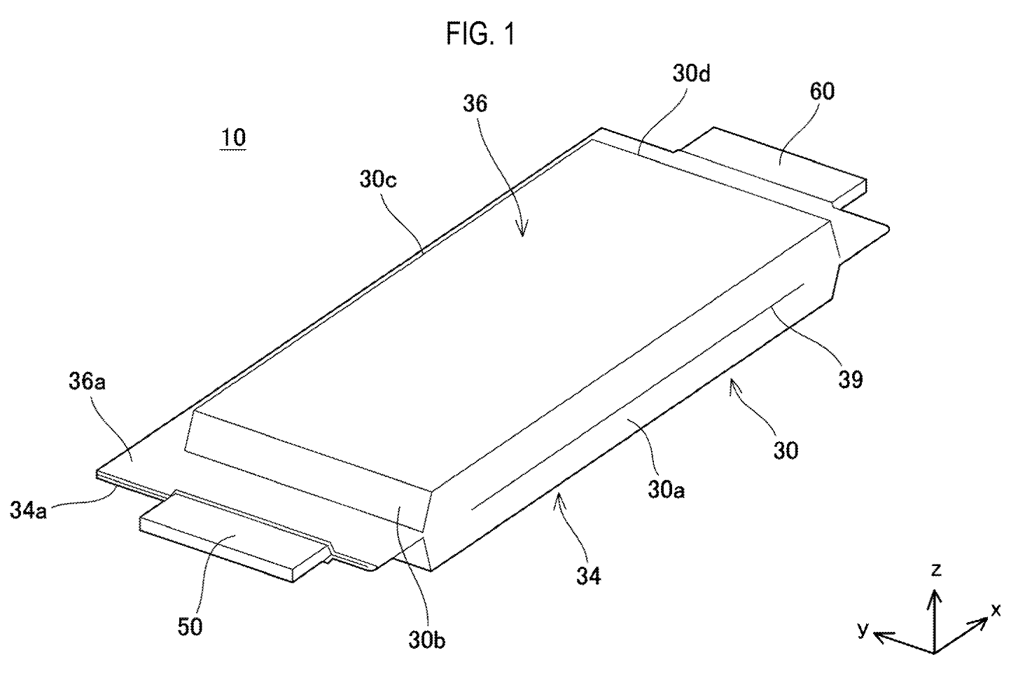

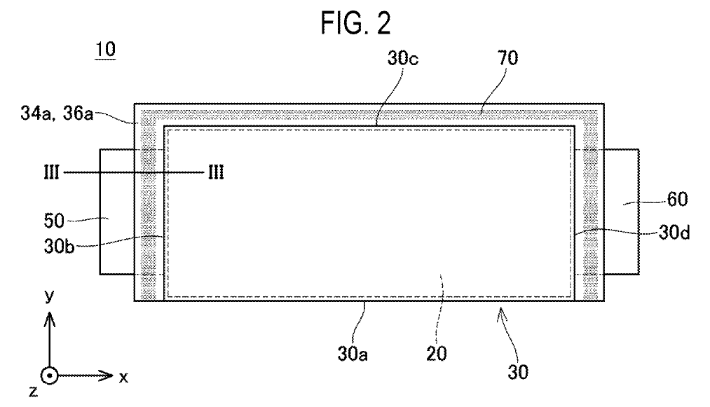

As shown in FIG. 1, the battery cell 10 of the embodiment has a rectangular flat plate shape. Hereinafter, the thickness direction of the battery cell 10 is referred to as a z direction, the longitudinal direction of the battery cell 10 is referred to as an x direction, and a direction orthogonal to the z direction and the x direction is referred to as a y direction. While the battery cell 10 is used, a plurality of the battery cells 10 is laminated in the z direction to constitute a battery module. As shown in FIG. 2, the battery cell 10 includes an outer package 30 and a power storage body 20 accommodated in the outer package 30. In addition, electrode plates 50, 60 are provided at both end portions of the battery cell 10 in the x direction. The electrode plate 50 is a positive electrode of the battery cell 10, and the electrode plate 60 is a negative electrode of the battery cell 10.

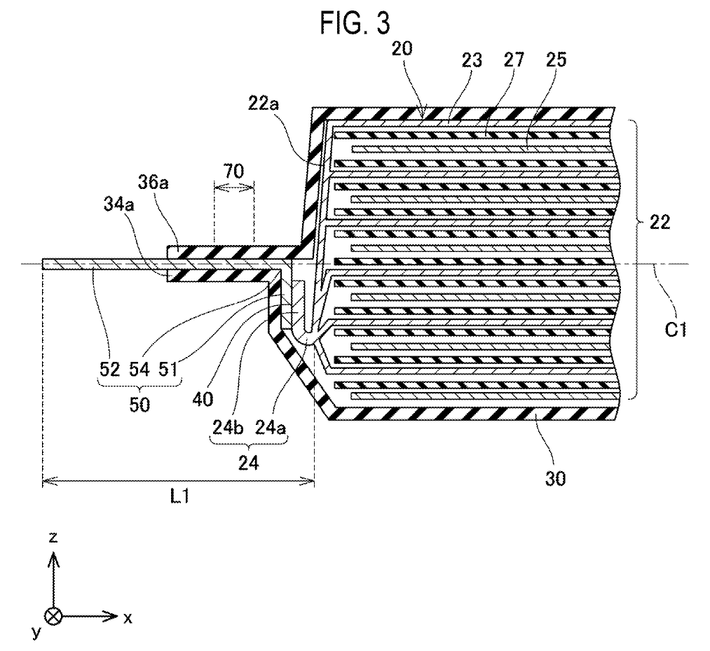

The power storage body 20 is a chargeable and dischargeable battery element and outputs a direct current voltage. As shown in FIG. 3, the power storage body 20 includes an electrode laminate 22 and a foil-collecting portion 24. The electrode laminate 22 is a laminate in which a plurality of positive electrode current collection foils 23 and a plurality of negative electrode current collection foils 25 are alternately laminated via a separator 27. The positive electrode current collection foil 23, the negative electrode current collection foil 25, and the separator 27 are laminated in the z direction. The foil-collecting portion 24 is a portion in which the plurality of positive electrode current collection foils 23 is collected. The foil-collecting portion 24 is provided on a side surface 22a of the electrode laminate 22. In addition, although not shown, a foil-collecting portion in which the plurality of negative electrode current collection foils 25 is collected is provided on a side surface of the electrode laminate 22 opposite to the side surface 22a. The power storage body 20 is immersed in an electrolytic solution filled in the outer package 30. The electrode plate 50 is connected to the foil-collecting portion 24 of the positive electrode. The electrode plate 60 is connected to the foil-collecting portion of the negative electrode.

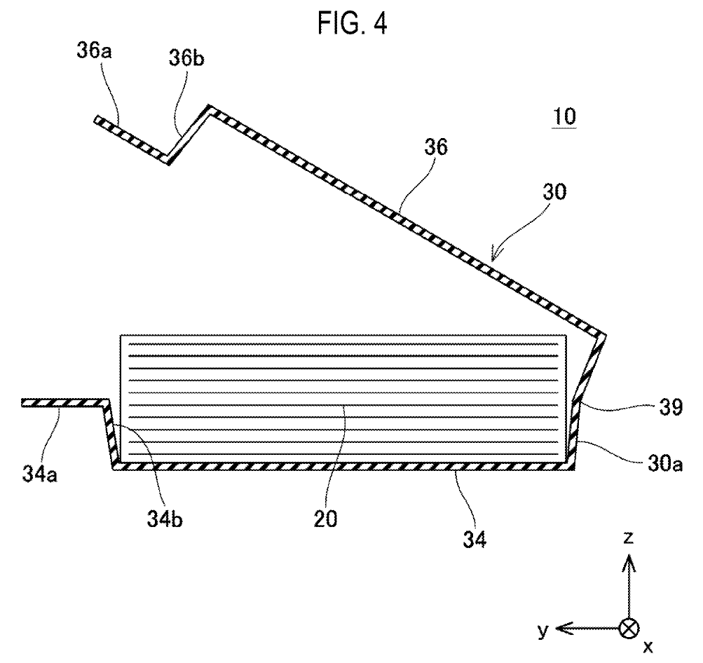

As shown in FIGS. 1 and 2, the outer package 30 includes side surfaces 30a to 30d. The side surfaces 30a, 30c are side surfaces along the x direction. The side surfaces 30b, 30d are side surfaces along the y direction. FIG. 4 is a cross-sectional view of the battery cell 10 before the outer package 30 is sealed. As shown in FIG. 4, the outer package 30 is configured by a thin film. The film constituting the outer package 30 is a laminate film in which a resin coating film is provided on both surfaces of an aluminum foil. The film constituting the outer package 30 is molded into a container shape having a bottom portion 34 and a lid portion 36 by an embossing process. A fold line 39 is provided on the side surface 30a of the outer package 30. The lid portion 36 can swing with respect to the bottom portion 34 about the fold line 39. The bottom portion 34 includes a frame portion 34a and a cup portion 34b. The cup portion 34b has a cup shape having a recessed portion on an upper surface. The frame portion 34a is a planar portion provided around the cup portion 34b. As shown in FIG. 1, the frame portion 34a is provided around the cup portion 34b, excluding the side surface 30a. As shown in FIG. 4, the power storage body 20 is disposed in the cup portion 34b. The lid portion 36 includes a frame portion 36a and a cap portion 36b. The cap portion 36b has a cap shape having a recessed portion on a lower surface. The frame portion 36a is a planar portion provided around the cap portion 36b. As shown in FIG. 1, the frame portion 36a is provided around the cap portion 36b, excluding the side surface 30a. In a case where the lid portion 36 is closed, the cap portion 36b covers a top portion of the power storage body 20. In addition, in a case where the lid portion 36 is closed, as shown in FIG. 1, the frame portion 36a is laminated on the frame portion 34a.

As shown in FIGS. 1 and 2, the electrode plates 50, 60 extend from the power storage body 20 to the outside of the outer package 30. The electrode plates 50, 60 extend from the inside to the outside of the outer package 30 through an interface between the frame portion 36a and the frame portion 34a. In FIG. 2, a region hatched with dots is a weld portion 70. The weld portion 70 is provided at a portion where the frame portion 36a and the frame portion 34a overlap each other. The weld portion 70 is a region in which the frame portion 34a is connected to the frame portion 36a by thermal welding. As shown in FIG. 2, the weld portion 70 extends along the outer periphery of the frame portions 34a, 36a. The weld portion 70 extends linearly across the electrode plates 50, 60. In a region where the electrode plates 50, 60 are not present in the weld portion 70, the frame portion 34a is welded to the frame portion 36a. In a region where the electrode plate 50 is present in the weld portion 70, the frame portion 34a is welded to a lower surface of the electrode plate 50, and the frame portion 36a is welded to an upper surface of the electrode plate 50. In a region where the electrode plate 60 is present in the weld portion 70, the frame portion 34a is welded to a lower surface of the electrode plate 60, and the frame portion 36a is welded to an upper surface of the electrode plate 60. In the weld portion 70, the outer package 30 is sealed.

Next, a connection structure between the electrode plate and the power storage body 20 will be described in detail. As described above, the electrode plate 50 is connected to the foil-collecting portion 24 of the positive electrode, and the electrode plate 60 is connected to the foil-collecting portion of the negative electrode. A connection structure between the electrode plate 50 and the foil-collecting portion 24 of the positive electrode is substantially the same as a connection structure between the electrode plate 60 and the foil-collecting portion of the negative electrode. Therefore, hereinafter, the connection structure between the electrode plate 50 and the foil-collecting portion 24 of the positive electrode will be described.

As shown in FIG. 3, the foil-collecting portion 24 protrudes from the side surface 22a of the electrode laminate 22. In FIG. 3, a center C1 is a center of the electrode laminate 22 in the laminating direction. The foil-collecting portion 24 is connected to the side surface 22a of the electrode laminate 22 at a position shifted from the center C1. The foil-collecting portion 24 includes a bent portion 24a and a plate-shaped portion 24b located on a distal end side of the bent portion 24a. The bent portion 24a is a portion in which the foil-collecting portion 24 is bent along the y direction. The foil-collecting portion 24 is bent at a substantially right angle at the bent portion 24a. Therefore, in the xz cross-section, the plate-shaped portion 24b extends along the laminating direction of the electrode laminate 22. The plate-shaped portion 24b extends from the bent portion 24a to an upper side (that is, a side closer to the center C1) along the side surface 22a of the electrode laminate 22. A distal end of the plate-shaped portion 24b is located on a lower side of the center C1.

The electrode plate 50 is a metal plate including a bent portion 54. The bent portion 54 is a portion in which the electrode plate 50 is bent along the y direction. The electrode plate 50 is bent at a substantially right angle at the bent portion 54. Therefore, in the xz cross-section, the electrode plate 50 has an L-shape. The electrode plate 50 includes plate portions 51, 52 on both sides of the bent portion 54. That is, the plate portion 52 is connected to the plate portion 51 via the bent portion 54. The plate portion 51 extends along the z direction and is disposed along the plate-shaped portion 24b of the foil-collecting portion 24. The plate portion 51 is in contact with an outer side surface of the plate-shaped portion 24b. In a joining portion 40 where the plate portion 51 and the plate-shaped portion 24b are in contact with each other, the plate portion 51 is joined to the plate-shaped portion 24b. The bent portion 54 is provided at an upper end of the plate portion 51. The plate portion 52 extends from the bent portion 54 in a direction away from the electrode laminate 22 along the x direction. The plate portion 52 is disposed at the center C1. That is, the plate portion 52 extends in the x direction at a position overlapping the center C1. The plate portion 52 extends from the inside to the outside of the outer package 30 through the interface between the frame portion 36a and the frame portion 34a. The weld portion 70 is provided at a position overlapping the plate portion 52. In the weld portion 70, the frame portion 36a is welded to an upper surface of the plate portion 52, and the frame portion 34a is welded to a lower surface of the plate portion 52.

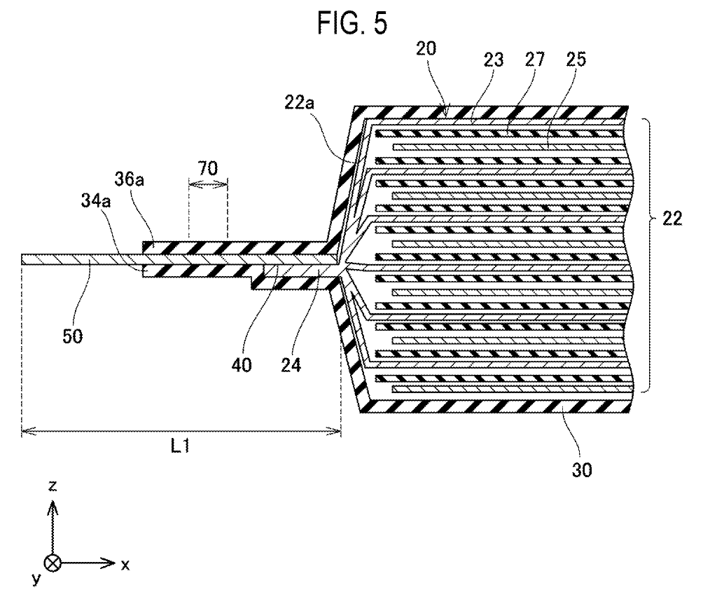

FIG. 5 shows a connection structure between the electrode plate 50 and the foil-collecting portion 24 of the battery cell of the comparative example. In the battery cell of the comparative example, the foil-collecting portion 24 extends linearly from the side surface 22a of the electrode laminate 22 along the x direction. In addition, the electrode plate 50 has a flat plate shape extending along the x direction, and a lower surface of an end portion of the electrode plate 50 is in contact with an upper surface of the foil-collecting portion 24. In the joining portion 40 where the electrode plate 50 and the foil-collecting portion 24 are in contact with each other, the electrode plate 50 is joined to the foil-collecting portion 24. The electrode plate 50 extends from the inside to the outside of the outer package 30 through the interface between the frame portion 36a and the frame portion 34a. The weld portion 70 is disposed outside the joining portion 40.

In the configuration of the comparative example of FIG. 5, since the joining portion 40 extends in the x direction, a dimension of the electrode plate 50 in the x direction is large. That is, a distance L1 from the side surface 22a of the electrode laminate 22 to the distal end of the electrode plate 50 is long. On the other hand, in the configuration of the embodiment shown in FIG. 3, since the joining portion 40 extends along the z direction, the dimension of the electrode plate 50 in the x direction is smaller than that in the configuration of FIG. 5. That is, the distance L1 from the side surface 22a of the electrode laminate 22 to the distal end of the electrode plate 50 is short. As described above, with the configuration of the embodiment, the dimension of the electrode plate in the x direction can be reduced, and the battery cell 10 can be reduced in size. Therefore, in a case where a plurality of the battery cells 10 is laminated to constitute a battery module, a size of the battery module can be reduced. Therefore, the battery module can store power with a high energy density.

In addition, with the configuration of the embodiment, since the foil-collecting portion 24 is connected to the side surface 22a of the electrode laminate 22 at a position shifted from the center C1, the plate portion 52 of the electrode plate 50 can be disposed at the center C1.

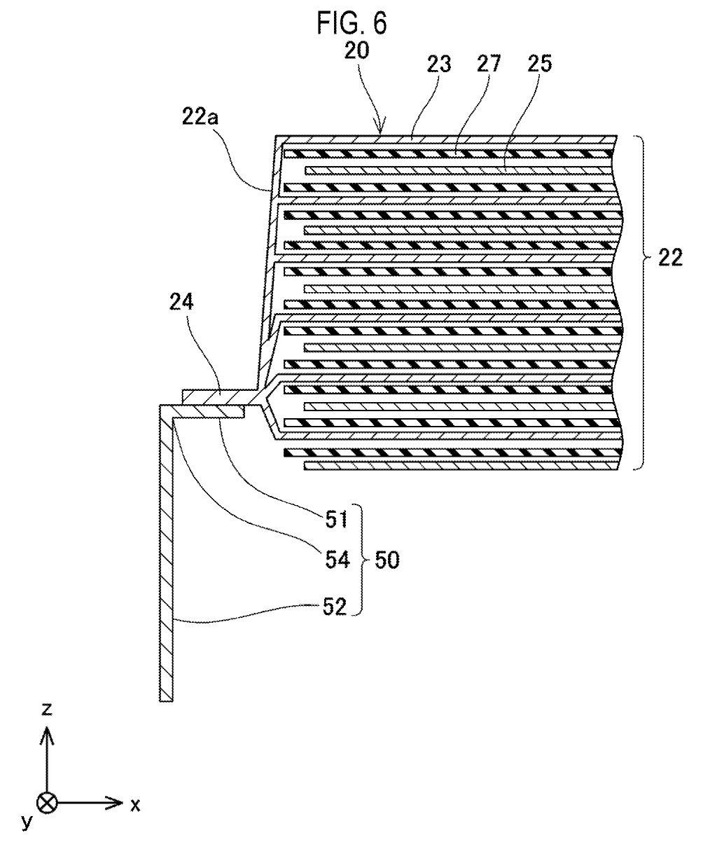

Next, a manufacturing method of the battery cell 10 will be described. First, the power storage body 20 is assembled as shown in FIG. 6. At this stage, the foil-collecting portion 24 extends linearly from the side surface 22a of the electrode laminate 22 along the x direction. Next, the plate portion 51 of the L-shaped electrode plate 50 is brought into contact with a lower surface of the foil-collecting portion 24, and the plate portion 51 is joined to the foil-collecting portion 24 by laser welding or the like. Next, as shown in FIG. 3, the foil-collecting portion 24 is bent such that the plate portion 52 is parallel to the x direction. Thereafter, the power storage body 20 is accommodated in the outer package 30, and the outer package 30 is welded by the weld portion 70 to complete the battery cell 10. With this method, the battery cell 10 can be easily manufactured.

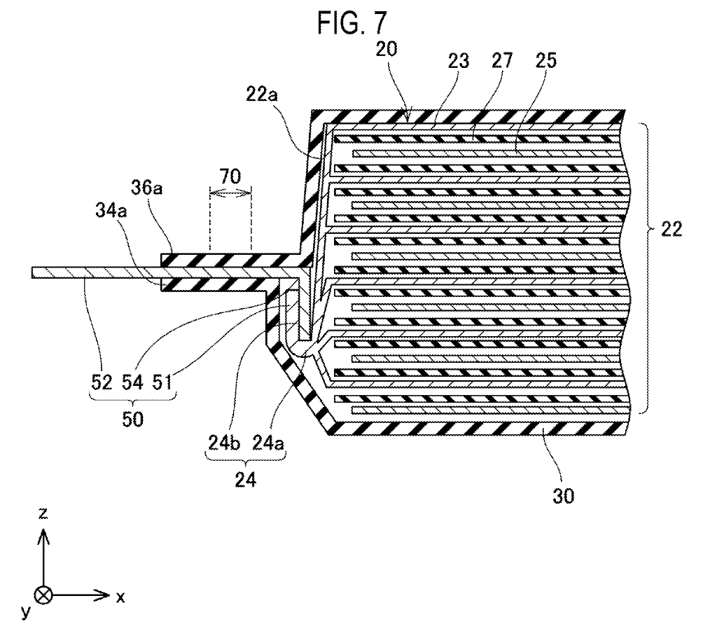

In the embodiment described above, the plate portion 51 of the electrode plate 50 is joined to the outer side surface of the foil-collecting portion 24. However, as shown in FIG. 7, the plate portion 51 may be joined to an inner side surface of the foil-collecting portion 24. Even in this configuration, the battery cell 10 can be reduced in size.

In addition, in the embodiment described above, the plate portion 52 is disposed at the center C1. However, in another embodiment, the plate portion 52 may be disposed at a position shifted from the center C1. For example, the foil-collecting portion 24 may be disposed at the center C1, and the plate portion 52 may be disposed at a position shifted from the center C1.

In addition, in the embodiment described above, in the xz cross-section, the plate portion 51 and the plate-shaped portion 24b extend parallel to the laminating direction (that is, the z direction) of the electrode laminate 22. However, the plate portion 51 and the plate-shaped portion 24b may extend along a direction having a predetermined angle (for example, an angle of 45 degrees or less) with respect to the laminating direction. In addition, in the embodiment described above, in the xz cross-section, the plate portion 52 extends parallel to a direction (that is, the x direction) orthogonal to the laminating direction. However, the plate portion 52 may extend along a direction having a predetermined angle (for example, an angle of 45 degrees or less) with respect to the x direction. Even in these configurations, the battery cell can be reduced in size.

The bent portion 24a of the embodiment is an example of the first bent portion. The plate-shaped portion 24b of the embodiment is an example of the specific portion. The plate portion 51 of the embodiment is an example of the first plate portion. The bent portion 54 of the embodiment is an example of the second bent portion. The plate portion 52 of the embodiment is an example of the second plate portion.

Although the embodiments have been described in detail above, these are merely an example and do not limit the scope of claims. The techniques described in the claims include various modifications and changes of the specific examples exemplified above. The technical elements described in the present specification or the drawings exhibit technical usefulness alone or in various combinations, and are not limited to the combinations described in the claims at the time of filing. Further, the techniques exemplified in the present specification or the drawings achieve a plurality of objectives at the same time, and achieving one of the objectives itself has technical usefulness.

What is claimed is:

1. A battery cell comprising:
a power storage body; and
an electrode plate, wherein:
the power storage body includes
an electrode laminate in which a plurality of positive electrode current collection foils and a plurality of negative electrode current collection foils are laminated, and
a foil-collecting portion in which the positive electrode current collection foils or the negative electrode current collection foils are collected, the foil-collecting portion protruding from a side surface of the electrode laminate;
the foil-collecting portion includes
a first bent portion, and
a specific portion connected to the electrode laminate via the first bent portion and extending along a laminating direction of the electrode laminate; and
the electrode plate includes
a first plate portion disposed along the specific portion and joined to the specific portion,
a second bent portion, and
a second plate portion connected to the first plate portion via the second bent portion and extending from the second bent portion in a direction away from the electrode laminate.

2. The battery cell according to claim 1, wherein:
the foil-collecting portion is connected to the side surface of the electrode laminate at a position shifted from a center of the electrode laminate in the laminating direction; and
the second plate portion is disposed at the center of the electrode laminate in the laminating direction.

3. The battery cell according to claim 1, further comprising a film material that encloses the power storage body, wherein the film material is welded to the second plate portion.
